(19) United States
(12) Patent Application Publication
(10) Pub. No.: US 2004/0225750 A1
(43) Pub. Date: Nov. 11, 2004

(54) Apparatus and method for determining next hop address using unified cache

(75) Inventors: Yong-Jun Lim, Seoul (KR); Hyun-Seok Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/772,583

(22) Filed: Feb. 6, 2004

(30) Foreign Application Priority Data
Feb. 6, 2003 (KR) 2003-7435

(51) Int. Cl. G06F 15/16

(52) U.S. Cl. 709/245

(57) ABSTRACT

An apparatus and method for determining a next hop address using a unified cache. The apparatus includes an on-off-link determining unit that determines whether a destination node is onlink or offlink based on a unified cache storing information on nodes connected to a predetermined network, an onlink equal address entry detecting unit that detects from the unified cache an entry storing a network layer address that matches a network layer address of the destination node determined as onlink, and a first link layer address determining unit that determines a link layer address stored in the entry detected by the onlink equal address entry detecting unit as a link layer address of a next hop node.

### BACKGROUND OF THE INVENTION

This application is based on and claims priority from Korean Patent Application No. 2003-7435, filed on Feb. 6, 2003, in the Korean Intellectual Property Office, the disclosure of which is incorporated herein in its entirety by reference.

1. Field of the Invention

The present invention relates to an apparatus and method for determining a next hop address in an Internet Protocol version 6 (IPv6) environment.

2. Description of the Related Art

FIG. 1 shows the configuration of a conventional apparatus for determining a next hop address in an IPv6 interface. Referring to FIG. 1, the conventional apparatus includes a destination cache 11, a neighbor cache 12, a default router list 13, and a prefix list 14. A network layer address of a next hop node, i.e., an IP address and a link layer address, is required to transmit a data packet to the next hop node. An IPv6 interface uses an address resolution protocol (ARP) to determine a link layer address of a next hop node. IP addresses are used as addresses of nodes in communication between the nodes. However, the ARP provides a procedure to dynamically obtain a link layer address of a counterpart node, e.g., an IEEE 802 address of an Ethernet card. Thus, a node does not require information on a link layer address of a counterpart node in an Internet environment, which contributes to expansion of the Internet and promotion of easy access to the Internet. The IPv6 interface uses the following algorithm to determine a link layer address of a next hop node.

For convenience, a node A is assumed includes the destination cache 11, the neighbor cache 12, the default router list 13, and the prefix list 14.

The destination cache 11 stores a maximum transmission unit (MTU) as well as network link layer addresses of destination nodes to which data packets have been transmitted, i.e., IP addresses of the destination nodes. In other words, the destination cache 11 stores an IP address C.IPv6 of a node C, an IP address H.IPv6 of a node H, an IP address L.IPv6 of a node L, and an IP address D.IPv6 of a node D. This indicates that the node A has transmitted data packets to the nodes C, H, L, and D.

The neighbor cache 12 stores network layer addresses (i.e., IP addresses) and link layer addresses of nodes connected to a link local network to which the neighbor cache 12 is linked, i.e., onlink nodes. In other words, the neighbor cache 12 performs the same functions as the ARP cache in the IPv6. The neighbor cache 12 also stores values indicating whether the destination nodes are onlink or offlink and values indicating whether the onlink nodes are substantially reachable. In other words, the neighbor cache 12 stores an IP address R1.IPv6 of a node R1, a link layer address R1.Eth of the node R1, a value of “1” indicating that the destination nodes are offlink, a value of “Reachable” indicating that the node R1 is reachable, an IP address R2.IPv6 of a node R2, a link layer address R2.Eth of the node R2, a value of “1” indicating that the destination nodes are offlink, a value of “Reachable” indicating that the node R2 is reachable, an IP address C.IPv6 of the node C, a link layer address C.Eth of the node C, a value of “0” indicating that the destination nodes are onlink, and a value of “Reachable” indicating that the node C is reachable. Thus, the nodes R1, R2, and C are onlink. Since the destination nodes of the nodes R1 and R2 are offlink, the nodes R1 and R2 on link are routers that transmit data packets outside a link local network in order to transmit the data packets to the destination nodes. In addition, the nodes R1, R2, and C are reachable. In other words, data packets can be transmitted to the nodes R1, R2, and C.

The prefix list 14 stores prefixes indicating types of networks. In particular, the prefix list 14 stores prefixes FE80::/80, FEC:0:0:0:3::/80, and 4800:600:0:0:C00:3::/80. According to IPv6 standards, a link local address always starts with FE80::/64. Thus, the prefix FE80::/80 indicates a link local address. The IPv6 standards prescribe that a site local address always starts with FEC0::/48 and subsequent 16 bits are a subnet ID. Thus, the prefix FEC0:0:0:0:3::/80 indicates a site local address and :3:: indicates a subnet ID. Moreover, according to the IPv6 standards, 4800:600:0:0:C00:3::/80 indicates a global unicast address. Since the prefixes of FE80::/80, FEC0:0:0:0:3::/80, and 4800:600:0:0:C00:3::/80 have a prefix length of 80, an interface ID of a network interface card (NIC) included in the node A is a 48-bit address that is the IEEE 802 address.

The default router list 13 stores IP addresses of onlink routers which transmit router advertisement messages. In a case where the destination nodes are offlink, the node A designates a random router as a next hop node from the default router list 13.

A conventional algorithm used for the determination of a link layer address of a next hop node in the IPv6 interface will now be described.

A determination is made whether the destination cache 11 has an entry corresponding to the IP address of a destination node. If the destination cache 11 has the entry corresponding to the IP address of the destination node, the entry is linked to an entry of the neighbor cache 12 pointed by a pointer.

If the destination cache 11 does not have the entry corresponding to the IP address of the destination node, a determination is made whether the prefix list 14 has a prefix corresponding to a prefix of the IP address of the destination node. If the prefix list 14 has the prefix corresponding to the prefix of the IP address of the destination node, the destination node is onlink. Thus, the IP address of the destination node is determined as an IP address of a next hop node. If the prefix list 14 does not have a prefix corresponding to the prefix of the IP address of the destination node, an IP address of a router stored in the default router list 13 is determined as an IP address of a next hop node and then linked to the entry of the neighbor cache 12 pointed by the pointer. In a case where the default router list 13 does not store entries, the IP address of the destination node is determined as an IP address of a next hop node.

Accordingly, when the IP address stored in the destination cache 11 or the default router list 13 is linked to the entry of the neighbor cache 12, the IP address and a link layer address of the next hop node are obtained. When the IP address of the next hop node is not linked to the entry of the neighbor cache 12, a neighbor solicitation message is transmitted to all of nodes connected to a link local network in a multicast way in order to solicit the nodes for link layer addresses. A neighbor advertisement message is received as a response to the neighbor solicitation message from an onlink destination node. A link layer address of the onlink destination node contained in the neighbor advertisement message is determined as a link layer address of a next hop node. Accordingly, a data packet is transmitted to a next hop node using a link layer address determined through the above-described procedure and a network layer address corresponding to the link layer address.

For example, a case where the node A transmits data to the node H will be explained. First, the node A checks whether an entry of the node H exists in a destination cache thereof. As shown in FIG. 1, since the entry of the node H exists in the destination cache of the node A, the entry of the node H is linked to an entry of the node R1 of a neighbor cache pointed by a pointer. Thus, since an IP address and a link layer address of a next hop node, i.e., the node R1, are obtained, a data packet is transmitted to the node R1.

As described above, in the conventional algorithm for next hop address determination, equivalent IP addresses, i.e., duplicate network layer addresses, are stored in several caches, which results in waste of a memory space. The memory waste brings about an unnecessary memory cycle, and thus a point is required to link the caches. As a result, load is imposed on a system.

### SUMMARY OF THE INVENTION

The present invention provides a unified cache for reduction in load on a system, an apparatus and method for constructing the unified cache, and an apparatus and method for determining a next hop address using the unified cache.

In one aspect of the present invention, there is provided a method of determining a next hop address using a unified cache, the method comprising: (a) determining whether a destination node is onlink or offlink based on a unified cache storing information on nodes linked to a predetermined network; (b) detecting an entry storing a network layer address that matches a network layer address of the destination node determined as onlink; and (c) determining a link layer address stored in the entry detected in (b) as a link layer address of a next hop node.

In another aspect of the present invention, there is provided an apparatus for determining a next hop address, the apparatus comprising: an on-off-link determining unit that determines whether a destination node is onlink or offlink based on a unified cache storing information on nodes connected to a predetermined network; an onlink equal address entry detecting unit that detects from the unified cache an entry storing a network layer address that matches a network layer address of the destination node determined as onlink; and a first link layer address determining unit that determines a link layer address stored in the entry detected by the onlink equal address entry detecting unit as a link layer address of a next hop node.

In another aspect of the present invention, there is provided a method of constructing and utilizing a unified cache, the method comprising: (a) receiving information regarding nodes connected to an IPv6 link local network and unifying an IPv6 destination cache, an IPv6 neighbor cache, an IPv6 default router cache, an IPv6 prefix cache based on the information received from the nodes to construct the unified cache; and (b) determining a link layer address of a next hop node based on the unified cache.

In another aspect of the present invention, there is provided a computer readable medium having embodied thereon a computer program for the above-described next hop address determination method.

In another aspect of the present invention, there is provided a computer readable medium having embodied thereon a computer program for the above-described method of constructing and utilizing a unified cache.

### BRIEF DESCRIPTION OF THE DRAWINGS

The above and other features and advantages of the present invention will become more apparent by describing in detail exemplary embodiments thereof with reference to the attached drawings in which:

FIG. 1 shows a configuration of an apparatus for determining a next hop address in an IPv6 interface;

FIG. 2 shows a configuration of apparatuses, for determining a next hop address, in which unified caches are constructed, according to an embodiment of the present invention;

FIG. 3 shows a configuration of a unified cache according to an embodiment of the present invention;

FIG. 4 shows a configuration of a unified cache router database constructing apparatus according to an embodiment of the present invention;

FIG. 5 shows a configuration of an apparatus for determining a next hop address using a unified cache, according to an embodiment of the present invention;

FIG. 6 is a flowchart of a method of constructing a unified cache router database, according to an embodiment of the present invention;

FIG. 7 is a flowchart of a method of determining a next hop address using a unified cache, according to an embodiment of the present invention;

FIGS. 8(A) and 8(B) constitute a flowchart of step A of the method of FIG. 7;

FIG. 9 is a flowchart of step B of the method of FIG. 7; and

FIG. 10 is a flowchart of a method of determining a next hop address using a unified cache, according to another embodiment of the present invention.

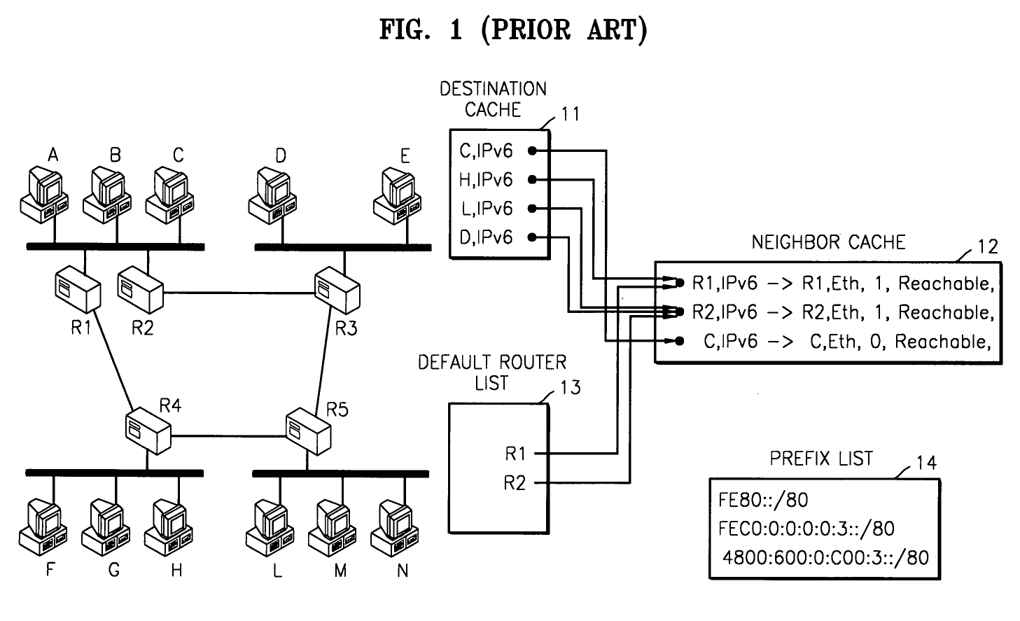

### DETAILED DESCRIPTION OF THE INVENTION

Hereinafter, preferred embodiments of the present invention will be described in detail with reference to the attached drawings.

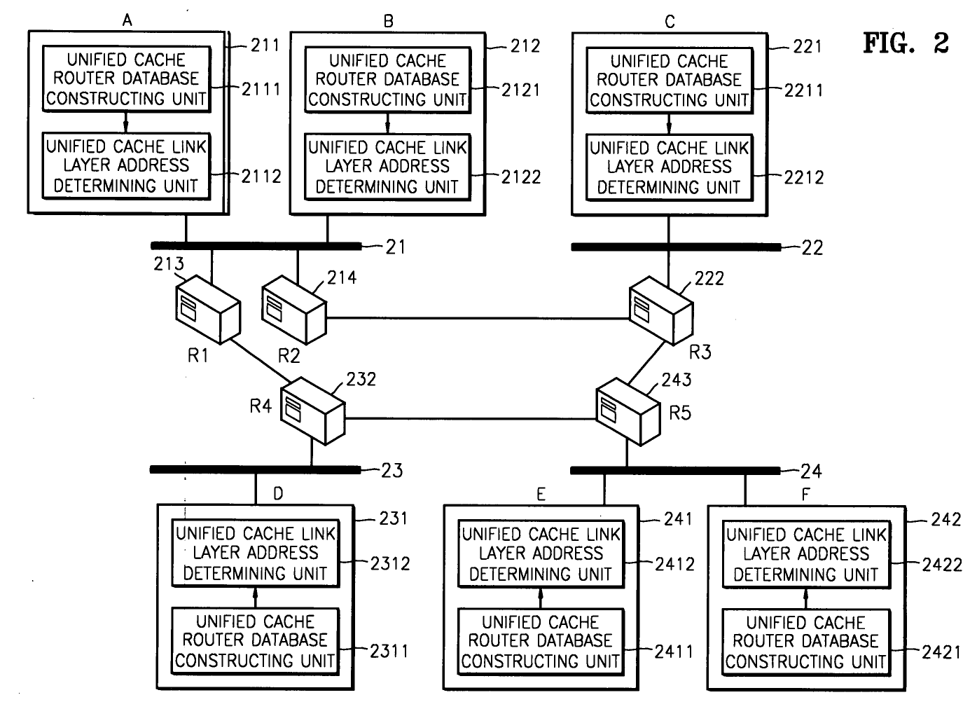

FIG. 2 shows the configuration of apparatuses for determining a next hop address in which unified caches are constructed, according to an embodiment of the present invention.

Cache-unified next hop address determining apparatuses 211, 212, 221, 231, 241, and 242 respectively include unified cache router database constructing units 2111, 2121, 2211, 2311, 2411, and 2421, and unified cache link layer address determining units 2112, 2122, 2212, 2312, 2412, and 2422. According to IPv6 standards, a link layer address of a next hop node is required to transmit a data packet within a link local network. The cache-unified next hop address determining apparatuses 211, 212, 221, 231, 241, and 242 each provide an algorithm to determine a link layer address of a next hop node in an optimized environment using a cache into which a destination cache, a neighbor cache, a default router list, and a prefix list are unified.

The unified cache router database constructing units 2111, 2121, 2211, 2311, 2411, and 2421 receive network layer addresses of routers 213, 214, 222, 232, and 243, prefix lengths of the network layer addresses, and link layer addresses of the routers 213, 214, 222, 232, and 243 via networks 21, 22, 23, and 24 which are connected to the routers 213, 214, 222, 232, and 243. The networks 21, 22, 23, and 24 are link local networks in compliance with the IPv6 standards. The unified cache router database constructing units 2111, 2121, 2211, 2311, 2411, and 2421 and 2421 store the network layer addresses of the routers 213, 214, 222, 232, and 243 in network layer address field of first entries, which are included unified caches including entries containing network layer address fields, prefix length fields, link layer address fields, onlink fields, and router fields and include network layer address fields, prefix length fields, link layer address fields, onlink fields, and router fields having no field values, lengths of prefixes of the network layer addresses of the routers 213, 214, 222, 232, and 243 in the prefix length fields of the first entries, the link layer addresses of the routers 213, 214, 222, 232, and 243 in the link layer address fields of the first entries, values indicating that the destination nodes are onlink in the onlink fields of the first entries, and router values in the router fields of the first entries. The network layer addresses may be link local addresses, site local addresses, or global unicast addresses according to the IPv6 standards. The prefixes may be prefixes of ink local networks, prefixes of site local networks, or prefixes of global networks according to the IPv6 standards. The link layer addresses may be IEEE 802 addresses or EUI-64 addresses of network interface cards according to the IPv6 standards. When systems of the cache-unified next hop address determining apparatuses 211, 212, 221, 231, 241, and 242 are supplied with power and then initialized, each of the systems transmits a router solicitation message to all of nodes connected to its link local network in a multicast way to store information on routers connected to its link local networks in its unified cache. When each of the systems receives router advertisement messages as responses to the router solicitation message from all of nodes connected to its link local network, each of the systems stores prefixes, link layer addresses, reachability, MTUs, and so forth contained in the router advertisement messages. For example, as can be seen in FIG. 2, the unified cache router database constructing unit 2111 of the node A 211 stores information about the router R1 213 and the router R2 214 in a unified cache. The unified cache router database constructing unit 2121 of the node B 212 stores information about the router R1 213 and the router R2 214 in its unified cache. The unified cache router database constructing unit 2211 of the node C 221 stores information about the router R3 222 in its unified cache. The unified cache router database constructing unit 2311 of the node D 231 stores information about the router R4 232 in its unified cache. The unified cache router database constructing unit 2411 of the node E 241 stores information about the router R5 243 in its unified cache.

The unified cache link layer address determining units 2112, 2122, 2212, 2312, 2412, and 2422 detect router entries, which include router fields with values indicating routers, from the unified caches. If the router entries are detected, the unified cache link layer address determining units 2112, 2122, 2212, 2312, 2412, and 2422 compare portions of network layer addresses of network layer address fields of the detected router entries corresponding to prefix lengths stored in prefix length fields of the detected router entries with portions of network layer addresses of destination nodes corresponding to prefix lengths stored in the prefix length fields of the detected router entries. If the portions of the network layer addresses of the detected router entries equal the portions of the network layer addresses of the destination nodes, the unified cache link layer address determining units 2112, 2122, 2212, 2312, 2412, 2422 determine the destination nodes as onlink. If the portions of the network layer addresses of the detected router entries do not equal the portions of the network layer addresses of the destination nodes, the unified cache link layer address determining units 2112, 2122, 2212, 2312, 2412, 2422 determine the destination nodes as offlink.

If the router entries are not detected, the unified cache link layer address determining units 2112, 2122, 2212, 2312, 2412, 2422 determine the destination nodes as onlink. Describing the node A 211 as an example, the detection of the router entry from the unified cache of the node A 211 indicates the existence of the routers 213 and 214, which connect the node A 211 to external networks, on the link local network 21 to which the node A 211 is connected. Thus, the node A determines whether destination nodes are connected to the link local network 21, if the destination nodes are connected to the link local network 21, the node A transmits data packets to the destination nodes. If the destination nodes are not connected to the link local network 21, the node A 211 transmits the data packets to the routers. In other words, if router entries are detected from the unified cache of the node A 211, a determination must be made whether the destination nodes are onlink or offlink. A case where the router entries are not detected from the unified cache of the node A 211 indicates the absence of the routers 213 and 214 which are to be connected to the link local network 21 to connect the node A 211 to external networks. Accordingly, the node A 211 determines the destination node as onlink and then transmits the data packets to the destination nodes.

When the unified cache link layer address determining units 2112, 2122, 2212, 2312, 2412, 2422 determine the destination nodes as onlink, the unified cache link layer address determining units 2112, 2122, 2212, 2312, 2412, and 2422 detect from the unified caches onlink equal address entries in which values of onlink fields indicate onlink and values of network layer address fields correspond to the network layer addresses of the destination nodes, and determine values of link layer address fields of the detected onlink equal address entries as link layer addresses of next hop nodes if the onlink equal address entries are detected. For example, in the case where a source node is the node A 211 and a destination node is the node B 212, if the node A 211 has sent a data packet to the node B 212, the transmission path of the data packet will be probably stored in the unified cache of the node A 211. Therefore, the node A 211 must check whether the unified cache includes an entry containing an IP address corresponding to an IP address of the node B 212. If the unified cache includes the entry containing the IP address corresponding to the IP address of the node B 212, this indicates that the node A 211 transmitted the data packet to the node B 212. Thus, the node A 211 determines a link layer address stored in a link layer address field of this entry as a link layer address of a next hop node and then transmits a data packet to the next hop node. Since the node B 212 is onlink, the node B 212 can be determined as the next hop node.

If the onlink equal address entries are not detected, the unified cache link layer determining units 2112, 2122, 2212, 2312, 2412, and 2422 solicit all of nodes connected to their networks for the transmission of link layer addresses of destination nodes, receive the link layer addresses as responses to the solicitation from the destination nodes via the networks 21, 22, 23, and 24, and determine the received link layer addresses as link layer addresses of next hop nodes. Next, the unified cache link layer determining units 2112, 2122, 2212, 2312, 2412, and 2422 store network layer addresses of the destination nodes in network layer address fields of second entries which are included in unified caches and include network layer address fields, prefix length fields, link layer address fields, onlink fields, and router fields having no field values, prefix lengths of the destination nodes in the prefix length fields of the second entries, link layer addresses of the destination nodes in the link layer address fields of the second entries, values indicating that the destination nodes are onlink in the onlink fields of the second entries, and values indicating that the destination nodes are not routers in the router fields of the second entries. In the above example, if the unified cache does not include the entry containing the IP address corresponding to the IP address of the node B 212, this indicates that the node A 211 did not transmit a data packet to the node B 212. Thus, the node A 211 must perform an address resolution procedure according to the IPv6 standards to receive a link layer address from the node B 212. In other words, the node A 211 transmits a neighbor solicitation message to the nodes 212, 213, and 214 connected to the link local network 21, in a multicast way. Next, when the node B 212 receives the neighbor solicitation message, the node B 212 transmits a neighbor advertisement message containing its link layer address to the node A 211 in the multicast way. Then, the node A 211 receives the neighbor advertisement message from the node B 212, determines the link layer address as a link layer address of a next hop node, and transmits a data packet to the next hop node. Since the node B 212 is onlink, the node B 212 can be determined as the next hop node. As described above, the node A 211 stores information about the node B 212 in the unified cache so as to refer to the information next time the node B 212 is determined as a next destination node.

If the unified cache link layer address determining units 2122, 2122, 2212, 2312, 2412, and 2422 determine the destination nodes as onlink, they detect from the unified caches offlink equal address entries in which values of onlink fields indicate offlink and values of network layer address fields correspond to the network layer addresses of the destination nodes, and determine values of link layer address fields of the offlink equal address entries as link layer addresses of next hop nodes if the offlink equal address entries are detected. For example, in the case where a source node is the node A 211 and a destination node is the node E 241, if the node A 211 has transmitted a data packet to the node E 241, information on the transmission path of the data packet is probably stored in the unified cache of the node A 211. Thus, the node A 211 must check whether the unified cache includes an entry containing an IP address corresponding to an IP address of the node E 241. If the unified cache includes the entry containing the IP address corresponding to the IP address of the node E 241, this indicates that the node A 211 transmitted the data packet to the node E 241. Therefore, the node A 211 determines a link layer address stored in a link layer address field of this entry as a link layer address of a next hop node to transmit the data packet to the next hop node. Since the node E 241 is offlink, a next hop node may be the node R1 213 or the node R2 214. In other words, a network layer address field of this entry may store an IP address of the node E 241, and the link layer address field of this entry may store a link layer address of the node R1 213 or a link layer address of the node R2 214. Accordingly, since the link layer address of the next hop node is determined as the link layer address of the node R1 213 or the node R2 214, the node A 211 transmits a data packet to a link local address corresponding to the link layer address of the node R1 213 or the node R2 214 in a unicast way.

If the offlink equal address entries are not detected, the unified cache link layer address determining units 2122, 2122, 2212, 2312, 2412, and 2422 determine values of the link layer address fields of the detected router entries as link layer addresses of next hop nodes, and store network layer addresses of destination nodes in network layer address fields of third entries, which are included in the unified caches and include network layer address fields, prefix length fields, link layer address fields, onlink fields, and router fields having no field values, prefix lengths in the prefix length fields of the third entries, link layer addresses of the detected router entries in the link layer address fields of the third entries, values indicating that the destination nodes are onlink in the onlink fields of the third entries, and values indicating that the destination nodes are not routers in the router fields of the third entries.

In the above example, if the unified cache does not include the entry containing the IP address corresponding to the IP address of the node E 241, this indicates that the node A 211 did not transmit a data packet to the node E 241. Thus, according to the IPv6 standards, the node A 211 transmits a data packet to one of the routers 213 and 214 connected to the link local network 21 to which the node A 211 is connected. According to the present invention, a value of a link layer address field of an entry including a router field whose value indicates a router, i.e., of a router entry, is determined as a link layer address of a next hop node. Since the link layer address of the next hop node is determined as the link layer address of the node R1 213 or the node R2 214, the node A 211 transmits a data packet to a link local address corresponding to the link layer address of the node R1 213 or the node R2 214 in the unicast way. As described above, the node A 211 stores information about the node E 241 in its unified cache so as to refer to the information next time a destination node is the node E 241.

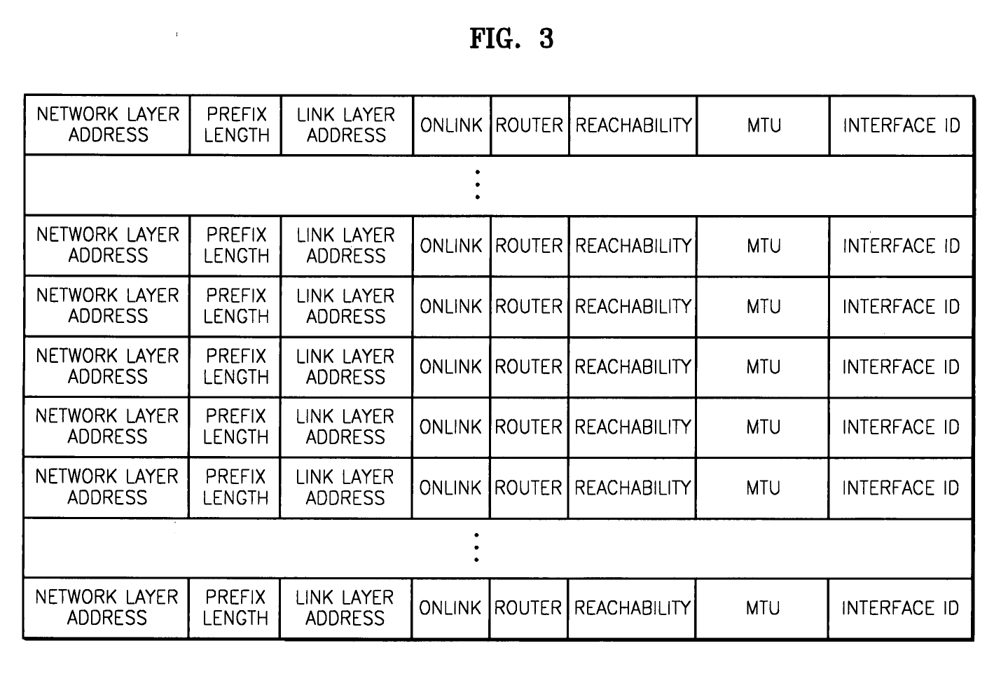

FIG. 3 shows the configuration of a unified cache according to an embodiment of the present invention.

Each of entries of the unified cache includes a network layer address field, a prefix length field, a link layer address field, an onlink field, a router field, a reachability field, a MTU field, and an interface ID field.

The network layer field stores a network layer address of a destination node to which a node transmitted a data packet. Thus, the network layer field serves as an index which connects the node to a link layer address of a next hop node without performing address resolution. Here, the network layer address may be a link local address, a site local address, or a global unicast address according to the IPv6 standards. Thus, one node may include an entry storing a link local address, an entry storing a site local address, and an entry storing a global unicast address. According to the IPv6 standards, the network layer address is 128 bits.

The prefix length field stores the length of a prefix of the network layer address of the destination node. The prefix of the destination node is compared with prefixes transmitted from routers to determine whether the destination node is onlink or offlink. In other words, when an IP address indicates a node, a prefix of the IP address indicates a network to which the node is connected. Thus, if a corresponding prefix exists, a source node and a destination node are connected to the same network. As a result, the destination node is determined as onlink. If the corresponding prefix does not exist, the source node and the destination node are connected to different networks. As a result, the destination node is determined as offlink.

The link layer address field stores a link layer address of the destination node when the destination node is onlink, while storing a link layer address of an onlink router when the destination node is offlink. If the destination node is onlink, the destination node is a next hop node. Consequently, the link layer address field stores the link layer address of the destination node. If the destination node is offlink, the destination node is connected to another link local network to which the source node is not connected. Thus, a random onlink router, which is connected to the link local network connected with the source node, is determined as a next hop node to transmit a data packet to the destination node. Accordingly, the link layer address field stores a link layer address of the random onlink router. Here, the link layer address is an IEEE 802 address or a EUI-64 address of a network interface card according to the IPv6 standards. According to the IPv6 standards, when the link layer address is the IEEE 802 address, it is 48 bits. When the link layer address is the EUI-64 address, it is 64 bits. As a result, the prefix length stored in the prefix length field is 80 bits when the link layer address is the IEEE 802 address but 64 bits when the link layer address is the EUI-64 address.

When the destination node is onlink, the onlink field stores a value indicating that the destination node is onlink. In contrast, when the destination node is offlink, the onlink fields stores a value indicating that the destination node is offlink. According to the IPv6 standards, in order to find a next hop address, next hop node determination starts with the comparison of a 128-bit IP address with a 128-bit IP address in a destination cache in a bit mask way, which imposes a lot of load on systems. However, in the present invention, a determination is made whether entries of unified caches are onlink or offlink using onlink fields, which can reduce load on systems. This is because the onlink fields are in charge of only the indication of onlink or offlink, resulting in the use of 1 bit.

When a node having a network layer address stored in the network layer address field is a router, the router field stores a value indicating that the node is the router. In contrast, when the node having the network layer address stored in the network layer address field is not the router, the router field stores a value indicating that the node is not the router. When a system having a unified cache is supplied with power, the system stores information about a router connected to its link local network in the unified cache. Since the router is onlink, the network layer address field stores an IP address of the router, and the link layer address field stores an ID of a network interface card of the router, i.e., an MAC address and the like. If the destination node is offlink, the router field is used to quickly detect a router entry from the unified cache. This is because the router field is only responsible for an indication whether a node is a router or not, resulting in the use of 1 bit. An entry whose router field stores a value indicating a router, i.e., a router entry, is stored in a memory ahead of other entries. In general, a minority of nodes are connected to a link local network. In other words, since most of destination nodes are offlink, routers may mainly be next hop nodes. Thus, frequently used entries can be located in preceding positions of the memory, which can reduce a search time.

In a case where the destination node is reachable, the reachability field stores a value indicating that the destination node is reachable. In an event that the destination node is unreachable, the reachability field stores a value indicating that the node is unreachable. According to the IPv6 standards, the reachability field is 3 bits.

The MTU field stores a value indicating a maximum amount of data to be transmitted via a network. When a transmitted data packet exceeds the value stored in the MTU field, the source node must slice and retransmit the data packet. According to the IPv6 standards, the reachability field is 11 bits.

The interface ID field stores an IEEE 802 address or a EUI-64 address of a network interface card of the node having the network layer address stored in the network layer address field. For the reception and transmission of a data packet, a link layer address as well as a network layer address is required. In other words, the source node must also send the link layer address to receive a response to the transmitted data packet. That is, the interface ID field stores the IEEE 802 address or the EUI-64 address of the network interface card that is the link layer address of the source node.

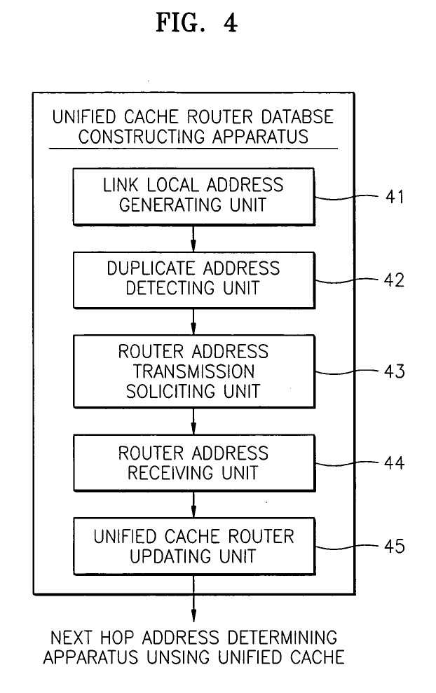

FIG. 4 shows the configuration of an apparatus for constructing a unified cache router database, according to an embodiment of the present invention.

The apparatus includes a link local address generating unit 41, a duplicate address detecting unit 42, a router address transmission soliciting unit 43, a router address receiving unit 44, and a unified cache router updating unit 45.

For descriptions with reference to FIG. 4, a network is a link local network according to the IPv6 standards, a network layer address is a link local address, a site local address, or a global unicast address according to the IPv6 standards, a prefix is a prefix of the link local network, a prefix of a site local network, or a prefix of a global network according to the IPv6 standards, and a link layer address is an IEEE 802 address or a EUI-64 address of a network interface card according to the IPv6 standards.

The link local address generating unit 41 generates a link local address. IPv6 address auto-configuration enables a node to combine an interface ID of a network interface card with a prefix FE80:: indicating a link local network to generate a temporary link local address when a system is supplied with power and then initialized.

The duplicate address detecting unit 42 detects a node having an address corresponding to the temporary link local address generated by the link local address generating unit 41, among nodes connected to the link local network. Since the temporary link local address is automatically generated regardless of the other nodes, a checking operation must be performed whether the temporary link local address correspond to link local addresses of the nodes connected to the link local network. According to IPv6 duplicate address detection, the duplicate address detecting unit 42 transmits a neighbor solicitation message and then receives a neighbor advertisement message as a response to the neighbor solicitation message. This indicates that other nodes on the local link network use the temporary link local address. Thus, the duplicate address detecting unit 42 stops the address auto-configuration and manually sets an address. The duplicate address detecting unit 42 receives a router advertisement message from a router on the local link network, receives a site local address or a global unicast address from a Dynamic Host Configuration Protocol version 6 (DHCPv6) server when the router advertisement message indicates “stateful”, or receives a prefix from the router when the router advertisement message indicates “stateless”, and generates a site local address or a global unicast address.

When the duplicate address detecting unit 42 does not detect the node having the duplicate address, the router address transmission soliciting unit 43 regards the temporary link local address generated by the link local address generating unit 41 as a source address and solicits transmission of the prefix and link layer address of the router from the router via the link local network. According to the IPv6 standards, the router address transmission soliciting unit 43 sends the router solicitation message for transmission of the prefix and link layer address of the router in the multicast way.

The router address receiving unit 44 receives the prefix and link layer address of the router as a response to the transmission solicitation from the router via the link local network. According to the IPv6 standards, the router address receiving unit 44 receives a router advertisement message as a response to the router solicitation message. The router advertisement message contains the prefix and link layer address of the router.

The unified cache router updating unit 45 is included in a unified cache containing entries with network layer address fields, prefix length fields, link layer address fields, onlink fields, and router fields. The unified cache router updating unit 45 stores a network layer address corresponding to the link layer address of the router in a network layer address field of an entry having the network layer address field, a prefix length field, a link layer address field, an onlink field, and a router field with no field values, a length of a prefix of the router in the prefix length field of the entry, the link layer address of the router in the link layer address field of the entry, a value indicating onlink in the onlink field of the entry, and a value indicating a router in the router field of the entry. When the unified cache router updating unit 45 receives the router advertisement message from the router, it generates a new router entry. In other words, the unified cache router updating unit 45 stores a network layer address made by adding a prefix of a link local network, a prefix of a site local network, or a prefix of a global network to the link layer address of the router, in the network layer address field of the entry, the length of the prefix of the router in the prefix length field of the entry, and the link layer address of the router in the link layer address field of the entry. In this case, since the router is onlink, the unified cache router updating unit 45 stores a value indicating that the router is onlink, in the onlink field of the entry and a value indicating the router, in the router field of the entry.

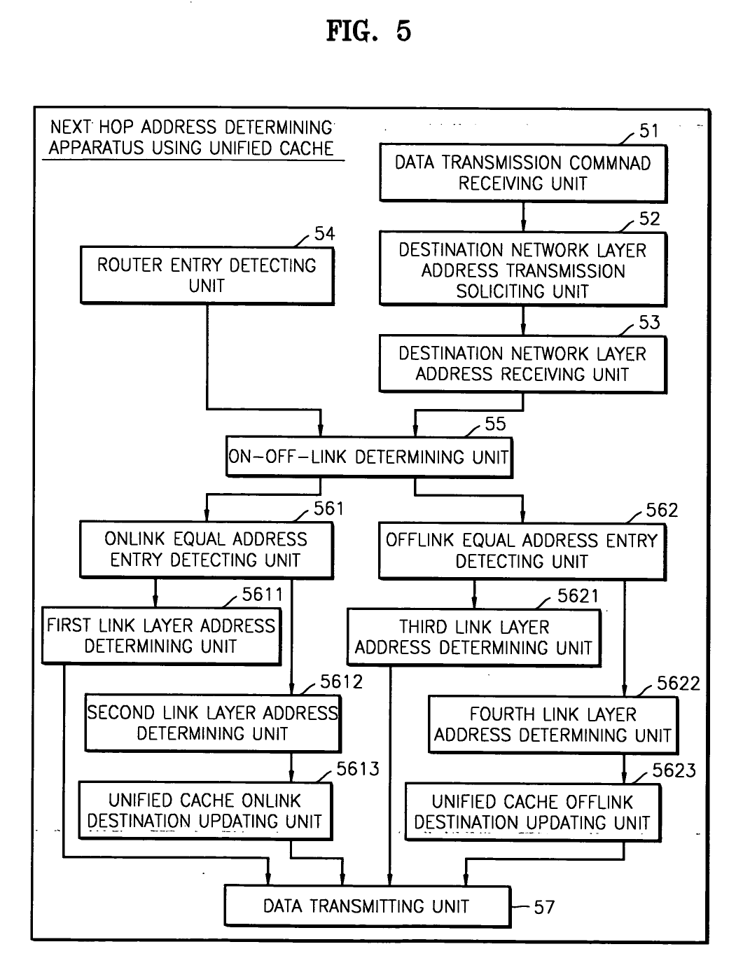

FIG. 5 shows the configuration of an apparatus for determining a next hop address using a unified cache, according to an embodiment of the present invention. Referring to FIG. 5, the apparatus includes a data transmission command receiving unit 51, a destination network layer address transmission soliciting unit 52, a destination network layer address receiving unit 53, a router entry detecting unit 54, an on-off-link determining unit 55, an onlink equal address entry detecting unit 561, an offlink equal address entry detecting unit 562, a first link layer address determining unit 5611, a second link layer address determining unit 5612, a unified cache onlink destination updating unit 5613, an offlink equal address entry detecting unit 562, a third link layer determining unit 5621, a fourth link layer determining unit 5622, a unified cache offlink destination updating unit 5623, and a data transmitting unit 57.

The data transmission command receiving unit 51 receives from a user a command to transmit data to a destination node, slices the data into packets, and transmits the sliced packets.

When the data transmission command receiving unit 51 receives the command, the destination network layer address transmission soliciting unit 52 solicits a domain name server (not shown) for the transmission of a network layer address of the destination node. The domain name server is a system which transforms a domain name into an IP address. In other words, when the user inputs a domain name onto a web browser, the domain name server transforms the domain name into a numerical IP address.

The destination network layer address receiving unit 53 receives the network layer address of the destination node as a response to the transmission solicitation of the destination network layer address transmission soliciting unit 52 from the domain name server. The network layer address may be a link local address, a site local address, or a global unicast address in compliance with the IPv6 standards. In general, the link local address is automatically set in each node and thus may be the site local address or the global unicast address.

The router entry detecting unit 54 detects a router entry having a router field with a value indicating a router, from a unified cache including entries containing network layer address fields, prefix length fields, link layer address fields, onlink fields, and router fields. In a case where no routers exist on a link local network, the router entry detecting unit 54 cannot transmit the data packets to nodes on a site local network or a global network. Thus, the router entry detecting unit 54 unconditionally treats the destination node as onlink. Therefore, the router entry detecting unit 54 should check whether router entries exist in the unified cache.

When the router entry detecting unit 54 detects a router entry, the on-off-link determining unit 55 compares a portion of a network layer address of a network layer address field of the detected router entry corresponding to a prefix length stored in a prefix length field of the detected router entry with a portion of the network layer address of the destination node corresponding to a prefix length stored in the prefix length field of the detected router entry. If both the portions coincide with each other, the on-off-link determining unit 55 determines the destination node as onlink. If both the portions do not coincide with each other, the on-off-link determining unit 55 determines the destination node as offlink. When the router entry detecting unit 54 does not detect a router entry, the on-off-link determining unit 55 determines the destination node as off-link. If the router entry detecting unit 54 detects a router entry, i.e., a router exists on the link local network, the on-off-link determining unit 55 determines whether the destination node is onlink or offlink and transmits a data packet to the destination node or the router based on the determination result. A prefix received from the router is a basis for the determination of onlink or offlink. In the present invention, in order to effectively use a memory space, without storing an additional prefix of a router, a value corresponding to a value stored in a prefix length field is extracted from values stored in a network layer address field of a unified cache in a bit mask way and compared with a prefix of a destination node. If both prefixes coincide with each other, this indicates that a source node and the destination node are connected to an equal link local network. The prefix may be a prefix of a link local network, a prefix of a site local network, or a prefix of a global network according to the IPv6 standards.

When the on-off link determining unit 55 determines the destination node as onlink, the onlink equal address entry detecting unit 561 detects from the unified cache an onlink equal address entry in which a value of an onlink field indicates onlink and a value of a network layer address field corresponds to the network layer address of the destination node. The value of the network layer address field of the onlink equal address entry is an IP address of an onlink node and a value of a link layer address field of the onlink equal address entry is a link layer address of the onlink node. This is because the destination node is a next hop node and the network layer address field stores an IP address of the destination node on link, and thus the value of the network layer address field and the value of the link layer address field are the IP address of the destination node.

When the on-link equal address detecting unit 561 detects the onlink equal address entry, the first link layer address determining unit 5611 determines the value of the link layer address field of the detected onlink equal address entry as a link layer address of a next hop node. The detection of the onlink equal address entry indicates that a data packet was transmitted to the destination node. Thus, the link layer address of the next hop node may be stored in the link layer address field of the unified cache. Therefore, the value of the link layer address field of the detected onlink equal address entry is determined as the link layer address of the next hop node (which is onlink, and thus becomes the destination node). The link layer address is an IEEE 802 address or a EUI-64 address according to the IPv6 standards.

When the on-link equal address detecting unit 561 does not detect the onlink equal address entry, the second link layer address determining unit 5612 solicit all nodes connected to the network for the link layer address of the destination node, receives the link layer address as a response to the transmission solicitation from the destination node via the network, and determines the received link layer address as the link layer address of the next hop node. The non-detection of the onlink equal address entry indicates that a data packet was not previously transmitted to the destination node. Thus, the unified cache does not include an entry containing information about the destination node. Therefore, the second link layer address determining unit 5612 receives the link layer address from the destination node through IPv6 address resolution. In other words, the second link layer address determining unit 5612 transmits a neighbor solicitation message in the multicast way to solicit all nodes on the link local network for the transmission of the link layer address. Next, the destination node receives the neighbor solicitation message and then transmits a neighbor advertisement message containing link layer address to the second link layer address determining unit 5612 in the unicast way. Thereafter, the second link layer address determining unit 5612 receives the neighbor advertisement messages and determines the link layer address contained in the neighbor advertisement message as the link layer address of the next hop node (which is onlink and thus becomes destination nodes).

The unified cache onlink destination updating unit 5613 stores the network layer address of the destination node in a network layer address field of an entry, which is included in the unified cache and includes the network layer address field, a prefix layer field, a link layer address field, an onlink field, a router field with no field values, a prefix length in the prefix length field of the entry, the link layer address of the destination node in the link layer address field of the entry, a value indicating onlink in the onlink field of the entry, and a value indicating that the destination node is not a router in the router field of the entry.

In a case where the onlink equal address detecting unit 561 does not detect the onlink equal layer entry and thus the second link layer address determining unit 5612 performs the address resolution to receive the link layer address from the destination node, the unified cache onlink destination updating unit 5613 stores information about the destination node in the unified cache. As a result, next time the same node is a destination node, the unified cache onlink destination updating unit 5613 can rapidly and effectively determine a link layer address of a next hop node using the unified cache. Since this case indicates that the next hop node becomes a destination node, a value indicating that the destination node is onlink is stored in an onlink field of an entry in which information about the destination node is stored, and a value indicating that the destination node is not a router is stored in a router field of the entry.

When on-off-link determining unit 55 determines the destination node as onlink, the offlink equal address entry detecting unit 562 detects from the unified cache an offlink equal address entry in which a value of an onlink field indicates offlink and a value of a network layer address corresponds to the network layer address of the destination node. The value of the network layer address of the offlink equal address entry is an IP address of an offlink node and a value of a link layer address of the offlink equal address entry is a link layer address of another node, i.e., a router. This is because the destination node is off the link local network. Thus, since a next hop node is the router and the IP address of the destination node is stored in the network layer address field, the value of the network layer address field and the value of the link layer address field correspond to IP addresses of different nodes, respectively.

When the offlink equal address entry detecting unit 562 detects the offlink equal address entry, the third link layer address determining unit 5621 determines the value of the link layer address field of the offlink equal address entry as the link layer address of the next hop node. The detection of the offlink equal address entry indicates that a data packet was previously transmitted to the destination node. Thus, the link layer address of the next hop node may be stored in the link layer address field of the unified cache. Therefore, the third link layer address determining unit 5621 determines the value of the link layer address field of the detected offlink equal address entry as the link layer address of the next hop node (which is offlink and thus becomes a router). Here, the link layer address is an IEEE 802 address or a EUI-64 address of a network interface card according to the IPv6 standards.

When the offlink equal address entry detecting unit 562 does not detect the offlink equal address entry, the fourth link layer address determining unit 5622 determines the value of the link layer address of the detected router entry as the link layer address of the next hop node. The non-detection of the offlink equal address indicates that a data packet was not previously transmitted to the destination node. Thus, the unified cache does not include an entry containing information about the destination node. Therefore, the fourth link layer address determining unit 5622 receives a link layer address from a router connected to the link local network. The fourth link layer address determining unit 5622 determines a value of the link layer address field of the router entry detected by the router entry detecting unit 54 as a link layer address of a next hop node. If the unified cache includes a plurality of router entries, a router entry in a first position of the unified cache will be first detected. Thus, the router entry in the first position becomes a default router entry, and thus a value of a link layer address field of the default route entry is determined as a link layer address of a next hop node. However, a plurality of default router entries may be set to equally distribute data packets to be transmitted so as to prevent traffic congestion due to the concentration of the data packets on one router.

The unified cache offlink destination updating unit 5623 stores the network layer address of the destination node in a network layer address field of an entry, which is included in the unified cache and includes the network layer address field, a prefix length field, a link layer address field, an onlink field, and a router field with no field values, a prefix length in the prefix length field of the entry, the link layer address of the detected router entry in the link layer address field of the entry, a value indicating that the destination node is offlink in the onlink field of the entry, and a value indicating that the destination node is not a router in the router field of the entry. When the offlink equal address detecting unit 562 does not detect the offlink equal address entry and the fourth link layer address determining unit 5622 receives the link layer address from the router, the unified cache offlink destination updating unit 5623 stores information about the destination node in the unified cache. Next time the same node is a destination node, the unified cache offlink destination updating unit 5623 can rapidly and efficiently determine a link layer address of a next hop node using the unified cache. Here, since the next hop node is a router, a value indicating that the destination node is offlink is stored in an onlink field of an entry in which information about the destination node is stored, and a value indicating that the destination node is not a router is stored in a router field of the entry.

When the first, second, third, or fourth link layer address determining unit 5611, 5612, 5621, or 5622 determines the link layer address, the data transmitting unit 57 transmits data to a next hop node via a network. When the link layer address, i.e., an ID of the network interface card, is determined, a link local address, which is obtained by adding the ID of the network interface card to a prefix FE80:: indicating the link local network, is determined as an IPv6 address. Thus, a data packet can be transmitted to a next hop node with the determined link local address and a link layer address on a link local network.

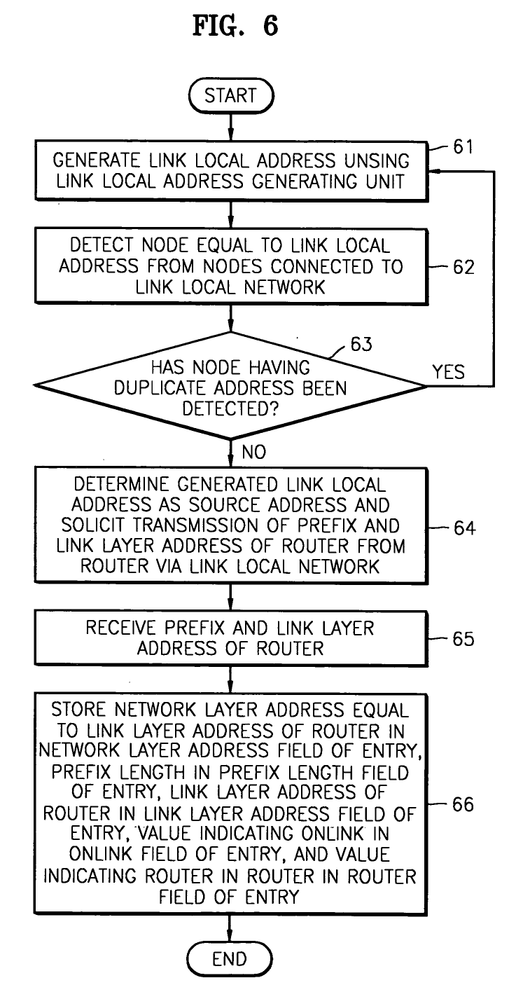

FIG. 6 is a flowchart of a method of constructing a unified cache router database, according to an embodiment of the present invention.

In step 61, a link local address is generated using a link local address generating unit. In step 62, a detection of a node corresponding to the link local address from nodes connected to a link local network is performed. In step 63, a determination is made whether the node having the duplicate address is detected. If the determination is made that the node having the duplicate address is not detected in step 63, in step 64, the generated link local address is determined as a source address and the transmission of a prefix and link layer address of a router is solicited from the router via the link local network. In step 65, the prefix and link layer address of the router is received as a response to the solicitation from the router via the link local network. In step 66, a network layer address corresponding to the link layer address of the router is stored in a network layer address field of an entry, which is included in a unified cache including entries containing network layer address fields, prefix length fields, link layer address fields, onlink fields, and router fields and which includes a network layer address field, a prefix length, field, a link layer address field, an onlink field, and a router field with no field values, a prefix length of the router is stored in the prefix length field of the entry, a link layer address of the router is stored in the link layer address field of the entry, a value indicating onlink is stored in the onlink field of the entry, and a value indicating a router is stored in the router field of the entry. Here, the network layer address may be a link local address, a site local address, or a global unicast address according to the IPv6 standards, the prefix may be a prefix of a link local network, a prefix of a site local network, or a prefix of a global network according to the IPv6 standards, and the link local address may be an IEEE 802 address or a EUI-64 address of a network interface card according to the IPv6 standards.

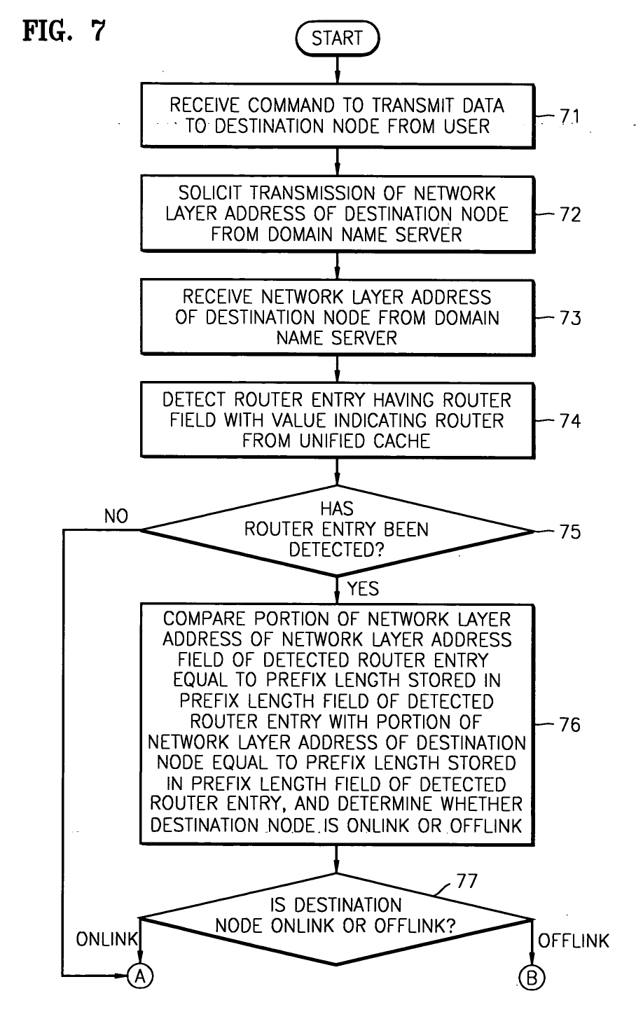

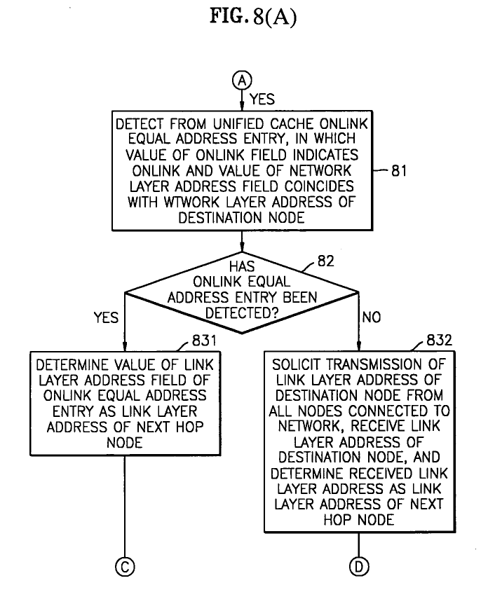

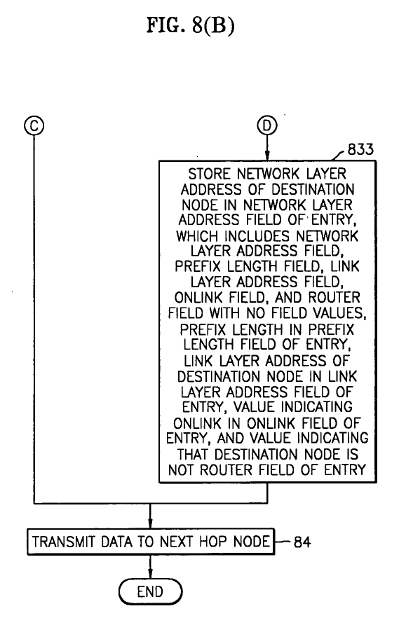

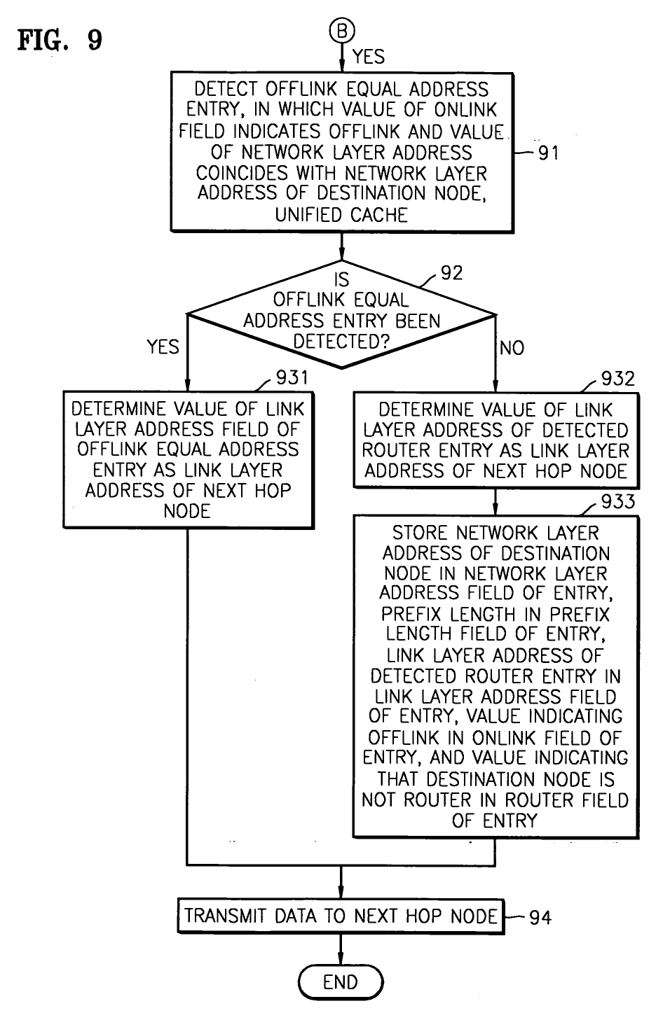

FIG. 7 is a flowchart of a method of determining a next hop address using a unified cache according to an embodiment of the present invention, FIGS. 8(A) and 8(B) constitute a flowchart of step A of FIG. 7, and FIG. 9 is a flowchart of step B of FIG. 7.

In step 71, a command to transmit data to a destination node is received from a user. In step 72, the transmission of a network layer address of the destination node is solicited from a domain name server. In step 73, the network layer address of the destination node is received as a response to the solicitation from the domain name server. In step 74, a router entry having a router field with a value indicating a router is detected from a unified cache including entries containing network layer address fields, prefix length fields, link layer address fields, onlink fields, and router fields. In step 75, a determination is made whether the router entry is detected. If in step 75, the determination is made that the router entry is detected, in step 76, a portion of a network layer address of a network layer address field of the detected router entry corresponding to a prefix length stored in a prefix length field of the detected router entry is compared with a portion of a network layer address of a destination node corresponding to the prefix length stored in the prefix length field of the detected router entry, the destination node is determined as onlink if both the portions coincide with each other, and the destination node is determined as offlink if both the portions do not coincide with each other. If in step 75, the determination is made that the router entry is not detected, in step 76, the destination node is determined as onlink.

In step 77, a determination is made whether the destination is onlink or offlink. If in step 77, the destination is onlink, in step 81, an onlink equal address entry, in which a value of an onlink field indicates onlink and a value of a network layer address field coincides with a network layer address of a destination node, is detected from a unified cache. In step 82, a determination is made whether the onlink equal address entry is detected. If in step 82, the determination is made that the onlink equal address entry is detected, in step 831, a value of a link layer address field of the onlink equal address entry is determined as a link layer address of a next hop node. Here, the network layer address may be a link local address, a site local address, or a global unicast address according to the IPv6 standards, the prefix may be a prefix of a link local network, a prefix of a site local network, or a prefix of a global network according to the IPv6 standards, and the link layer address may be an IEEE 802 address or a EUI-64 address according to the IPv6 standards.

If in step 82, the determination is made that the onlink equal address entry is not detected, in step 832, the transmission of a link layer address of a destination node is solicited from all nodes connected to a network, the link layer address of the destination node is received as a response to the solicitation from the destination node via the network, and the received link layer address is determined as a link layer address of a next hop node. In step 833, the network layer address of the destination node is stored in a network layer address field of an entry, which is included in the unified cache and includes the network layer address field, a prefix length field, a link layer address field, an onlink field, and a router field with no field values, a prefix length is stored in the prefix length field of the entry, the link layer address of the destination node is stored in the link layer address field of the entry, a value indicating onlink is stored in the onlink field of the entry, and a value indicating that the destination node is not a router is stored in the router field of the entry.

If in step 77, the determination is made that the destination node is offlink, in step 91, an offlink equal address entry, in which a value of an onlink field indicates offlink and a value of a network layer address coincides with the network layer address of the destination node, is detected from the unified cache. In step 92, a determination is made whether the offlink equal address entry is detected. If in step 92, the determination is made that the offlink equal address entry is detected, in step 931, a value of a link layer address field of the offlink equal address entry is determined as a link layer address of a next hop node.

If in step 92, the determination is made that the offlink equal address entry is not detected, in step 932, the value of the link layer address of the detected router entry is determined as a link layer address of a next hop node. In step 933, the network layer address of the destination node is stored in a network layer address field of an entry, which is included in the unified cache and includes the network layer address field, a prefix length field, a link layer address field, an onlink field, and a router field with no field values, a prefix length is stored in the prefix length field of the entry, the link layer address of the detected router entry is stored in the link layer address field of the entry, a value indicating offlink is stored in the onlink field of the entry, and a value indicating that the destination node is not a router is stored in the router field of the entry.

In step 84 or 94, data is transmitted to the next hop node via the network. Here, the network is an IPv6 link local network, the network layer address may be an IPv6 link local address, an IPv6 site local address, or an IPv6 global unicast address, the prefix may be a prefix of a link local network, a prefix of site local network, or a prefix of a global network according to the IPv6 standards, and the link layer address may be an IEEE 802 address or a EUI-64 address according to the IPv6 standards.

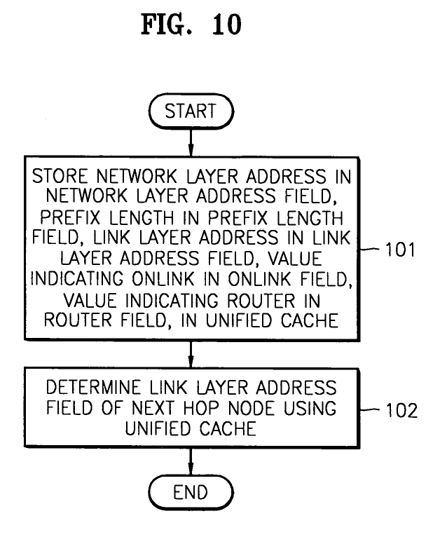

FIG. 10 is a flowchart of a method of determining a next hop address using a unified cache, according to an embodiment of the present invention.

In step 101, a prefix and link layer address of a router is received from the router via a network to which the router is connected, a network layer address corresponding to the link layer address of the router is stored in a network layer address field of a first entry, which is included in a unified cache including entries containing network layer address fields, prefix length fields, link layer address fields, onlink fields, and router fields and which includes the network layer address field, a prefix length field, a link layer address field, an onlink field, and a router field with no field values, a prefix length of the router is stored in the prefix length field of the first entry, the link layer address of the router is stored in the link layer address field of the first entry, a value indicating onlink is stored in the onlink field of the first entry, and a value indicating a router is stored in the router field of the first entry. In step 102, a router entry in which a value of a router field indicates a router is detected from the unified cache, a portion of a network layer address of a network layer address field of the detected router entry corresponding to a prefix length of a prefix length field of the router entry is compared with a portion of a network layer address of a destination node corresponding to a prefix length of the prefix length field of the detected router entry, the destination node is determined as onlink if both the portions coincide with each other, and the destination node is determined as offlink if both the portions do not coincide with each other. In contrast, in step 102, if the router entry is not detected, the destination node is determined as onlink, an onlink equal address entry in which a value of an onlink field indicates onlink and a value of a network layer address field coincides with the network layer address of the destination node is detected from the unified cache, and a value of a link layer address field of the onlink equal address entry is determined as a link layer address of a next hop node.

Also, in step 102, if the onlink equal address entry is not detected, the transmission of the link layer address of the destination node is solicited from all nodes connected to a network, the link layer address is received as a response to the solicitation from the destination node via the network, the received link layer address is determined as a link layer address of a next hop node, the network layer address of the destination node is stored in a network layer address field of a second entry which is included in the unified cache and includes the network layer address field, a prefix length field, a link layer address field, an onlink field, and a router field with no field values, a prefix length is stored in the prefix length field of the second entry, the link layer address of the destination node is stored in the link layer address field of the second entry, a value indicating that the destination node is onlink is stored in the onlink field of the second entry, and a value indicating that the destination node is not a router is stored in the router field of the second entry.

In addition, in step 102, if the destination node is offlink, an offlink equal address entry in which a value of an onlink field indicates offlink and a value of a network layer address field coincides with the network layer address of the destination node is detected from the unified cache, and a value of a link layer address field of the offlink equal address entry is determined as a link layer address of a next hop node.

Moreover, in step 102, if the offlink equal address entry is not detected, the value of the link layer address field of the detected router entry is determined as a link layer address of a next hop node, the network layer address of the destination node is stored in a network layer address field of a third entry which is included in the unified cache and includes the network layer address field, a prefix length field, a link layer address field, an onlink field, and a router field with no field values, a prefix length is stored in the prefix length field of the third entry, the link layer address of the router entry is stored in the link layer address field of the third entry, a value indicating that the destination node is offlink is stored in the onlink field of the third entry, and a value indicating that the destination node is not a router is stored in the router field of the third entry. Here, the network is an IPv6 link local network, the network layer address may be a link local address, a site local address, or a global unicast address according to the IPv6 standards, the prefix may be a prefix of a link local network, a prefix of a site local network, or a prefix of a global network according to the IPv6 standards, and the link layer address may be an IEEE 802 address or a EUI-64 address of a network interface card according to the IPv6 standards.

As described above, a destination cache, a neighbor cache, a default router list, and a prefix list can be unified into a cache. Thus, duplicate network layer addresses can be stored in the unified cache, which results in the effective use a memory space and a reduction in a memory cycle. As a result, load on a system can be reduced. In addition, only a link layer address can be managed without managing a network layer address and a link layer address to determine a next hop address. Thus, it is easy to manage entries in the memory. Moreover, since information about a router can be stored in a first position entry, a next hop address can be determined when most of destination nodes are offlink. Furthermore, separate memory structures can be changed into a unified memory structure, and thus redundant pointer operations can be removed, which results in a fast determination of a next hop address and an easy realization of the next hop address determination method through hardware. The realization of the next hop address determination method through hardware not through software can increase a speed of next hop address determination method and reduce load on the system.

Accordingly, the next hop address determination method can operate as a killer application in an application such as a network protocol chip necessary for networks.

The above-described embodiments of the present invention can be written as a program, which can be executed in a computer and in a general-purpose digital computer using a computer-readable recording medium.

A data structure used in the embodiments of the present invention can be written on a computer-readable recording medium via several means.

Computer-readable recording media include magnetic storage media (e.g., ROMs, floppy discs, hard discs, etc.), optical readers (e.g., CD-ROMs, DVDs, and the like), and carrier wave (e.g., the transmission over the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of determining a next hop address using a unified cache, the method comprising the steps of:
(a) determining whether a destination node is onlink or offlink based on a unified cache storing information regarding a plurality of nodes linked to a predetermined network;
(b) detecting from the unified cache an entry storing a network layer address that matches a network layer address of the destination node if the destination node is determined as onlink in step (a); and
(c) determining a link layer address stored in the entry detected in step (b) as a link layer address of a next hop node.

2. The method of claim 1, wherein the predetermined network is an Internet Protocol version 6 (IPv6) link local network, and the unified cache comprises an IPv6 destination cache, an IPv6 neighbor cache, an IPv6 basic router list, and an IPv6 prefix list which are unified.

3. The method of claim 1, wherein step (a) comprises:
(a-1) detecting from the unified cache an entry storing information regarding a router among the nodes, and
(a-2) comparing a prefix portion of a network layer address stored in the entry detected in (a-1) with a prefix portion of the network layer address of the destination node to determine whether the destination node is onlink or offlink.

4. The method of claim 1, further comprising the steps of:
(d) requesting all of the nodes connected to the predetermined network to transmit a link layer address of the destination node if the entry is not detected in step (b); and
(e) receiving the link layer address transmitted from the nodes and determining the received link layer address as the link layer address of the next hop node.

5. The method of claim 4, further comprising the step of (f) updating the unified cache using the received link layer address,
wherein step (a) comprises determining whether the destination node is onlink or offlink based on the updated unified cache.

6. The method of claim 1, further comprising:
(d) detecting from the unified cache an entry storing a network layer address that matches a network layer address of the destination node if the destination node is determined as offlink; and
(e) determining a link layer address stored in the entry detected in (d) as the link layer address of the next hop node.

7. The method of claim 6, further comprising determining the link layer address of a router among the nodes as the link layer address of the next hop node if the entry is not detected in (d).

8. An apparatus for determining a next hop address, the apparatus comprising:
an on-off-link determining unit that determines whether a destination node is onlink or offlink based on a unified cache storing information regarding plurality of nodes connected to a predetermined network;
an onlink equal address entry detecting unit that detects from the unified cache an entry storing a network layer address that matches a network layer address of the destination node if the destination node is determined as onlink; and
a first link layer address determining unit that determines a link layer address stored in the entry detected by the onlink equal address entry detecting unit as a link layer address of a next hop node.

9. The apparatus of claim 8, wherein the predetermined network is an IPv6 link local network, and the unified cache comprises an Internet Protocol version 6 (IPv6) destination cache, an IPv6 neighbor cache, an IPv6 default router list, and an IPv6 prefix list which are unified.

10. The apparatus of claim 8, further comprising a router entry detecting unit that detects from the unified cache an entry storing information on a router among the nodes,
wherein the on-off-link determining unit determines whether the destination node is onlink or offlink by comparing a prefix portion of a network layer address stored in the entry detected by the router entry detecting unit with a prefix portion of the network layer address of the destination node.

11. The apparatus of claim 8, further comprising a second link layer address determining unit that requests all of the nodes connected to the predetermined network to transmit a link layer address of the destination node if the entry is not detected by the on-off-link equal address entry detecting unit, receives the link layer address transmitted from the nodes, and determines the received link layer address as the link layer address of the next hop node.

12. The apparatus of claim 8, further comprising:
an offlink equal address entry detecting unit that detects from the unified cache an entry storing a network layer address that matches the network layer address of the destination node if the destination node is determined as offlink; and
a third link layer address determining unit that determines a link layer address stored in the entry detected by the offlink equal address entry detecting unit as the link layer address of the next hop node.

13. The apparatus of claim 12, further comprising a fourth link layer address determining unit that determines the link layer address of a router among the nodes as the link layer address of the next hop node if the entry is not detected by the offlink equal address entry detecting unit.

14. A method of constructing and utilizing a unified cache, the method comprising the steps of:
(a) receiving information regarding a plurality of nodes connected to an Internet Protocol version 6 (IPv6) link local network and unifying an IPv6 destination cache, an IPv6 neighbor cache, an IPv6 default router cache, an IPv6 prefix cache based on the information received from the nodes to construct the unified cache; and
(b) determining a link layer address of a next hop node based on the unified cache.

15. The method of claim 14, wherein the unified cache comprises entries including an onlink field storing a value indicating whether a destination node is onlink or offlink and a link layer address field that stores a link layer address of the destination node if the destination node is onlink and stores a link layer address of an onlink router if the destination node is offlink.

16. The method of claim 14, further comprising the steps of:
(c) creating a link local address of the predetermined network and detecting a node that has the same address as the created link local address; and
(d) requesting a router among the nodes to transmit information regarding the router by using the created link local address as a sender address if the node having the same address as the created link local address is not detected in step (c),
wherein step (a) comprises receiving the information transmitted from the router.

17. The method of claim 14, wherein (b) further comprises the steps of:
determining whether a destination node is onlink or offlink based on information on a router stored in the unified cache; and
determining a link layer address of the destination node determined as onlink as the link layer address of the next hop node.

18. A computer readable medium having embodied thereon a computer program for a method of determining a next hop address,
wherein the method comprises:
determining whether a destination node is onlink or offlink based on a unified cache storing information regarding a plurality of nodes linked to a predetermined network;
detecting an entry storing a network layer address that matches a network layer address of the destination node if the destination node is determined as onlink; and
determining a link layer address stored in the detected entry as a link layer address of a next hop node.

19. A computer readable medium having embodied thereon a computer program for a method of constructing and utilizing a unified cache,
wherein the method comprises:
receiving information regarding nodes connected to an Internet Protocol version 6 (IPv6) link local network and unifying an IPv6 destination cache, an IPv6 neighbor cache, an IPv6 default router cache, an IPv6 prefix cache based on the information received from the nodes to construct the unified cache; and
determining a link layer address of a next hop node based on the unified cache.
